(19) United States
(12) Patent Application Publication
(10) Pub. No.: US 2024/0034691 A1
(43) Pub. Date: Feb. 1, 2024

(54) MANUFACTURE OF A MULTICOLOURED CERAMIC COMPONENT

(71) Applicant: ROLEX SA, Geneva (CH)

(72) Inventors: Carine Bienvenu, Pringy (FR); Pierre Huguet, Allinges (FR)

(73) Assignee: ROLEX SA, Geneva (CH)

(21) Appl. No.: 18/357,291

(22) Filed: Jul. 24, 2023

(30) Foreign Application Priority Data
Jul. 29, 2022 (EP) 22187737.6

(51) Int. Cl. C04B 41/45; C04B 35/48; C04B 41/00; C04B 41/50; C04B 41/85; G04B 19/18; G04B 19/12; G04D 3/00

(52) U.S. Cl. CPC C04B 41/4574; C04B 35/48; C04B 41/4578; C04B 41/4535; C04B 41/0072; C04B 41/4519; C04B 41/5007; C04B 41/85; G04B 19/18; G04B 19/12; G04D 3/0069; G04D 3/0074; C04B 2235/3229; C04B 2235/3246; C04B 2235/3217; C04B 2235/663; C04B 2235/664; C04B 2235/6567; C04B 2235/9661

(57) ABSTRACT

The process for manufacturing a ceramic timepiece component includes:—manufacturing an intermediate component (E1) in the form of green body based on ceria-zirconia;—totally or partially debinding (E2) the intermediate component to obtain a debound intermediate component:—partially impregnating (E3) the debound intermediate component with at least one solution comprising at least one metal salt, on one portion only of its surface, to obtain an impregnated debound intermediate component:—sintering and thermally treating (E4) the impregnated debound intermediate component by performing at least one heat treatment under a reducing atmosphere (E42; E41′).

This application claims priority of European patent application No. EP22187737.6 filed Jul. 29, 2022, the content of which is hereby incorporated by reference herein in its entirety.

### INTRODUCTION

The present invention relates to a timepiece component made of two-tone ceramic, or even multicoloured ceramic, based on zirconia, more particularly a timepiece component made of sintered technical ceramic. The invention also relates to a timepiece comprising such a timepiece component. The invention lastly relates to a process for manufacturing a timepiece component made of two-tone ceramic, or even multicoloured ceramic, based on zirconia.

### BACKGROUND ART

In the field of watchmaking, just as in jewellery, it is known to use components made of technical ceramic, which will also be referred to more simply as ceramic. The adjective “technical” refers to the high-performance properties of the chosen ceramics. Specifically, these technical ceramics may achieve very high mechanical, thermal or even electrical, and/or biochemical properties and also a chemical inertia and an anti-magnetism, which make them suitable for use for forming timepiece components, notably timepiece movement components, but also watch exterior components. Technical ceramics differ from conventional ceramics due to their composition, since they are derived from purified synthetic powders and not from natural mineral powders such as for example feldspar or kaolin.

Among technical ceramics, zirconia-based ceramics are commonly used because they have high mechanical properties. However, one drawback of zirconia-based ceramics is that they are naturally in the form of a white-coloured body. One of the requirements of watchmaking is the attractive appearance of the material used, which naturally includes the colour. There are thus several steps for colouring such ceramics in the prior art, for example by the use of colouring pigments, which complicate the manufacturing process, while adding other drawbacks. Notably, a limit to the use of these ceramic components originates from the difficulty, or even impossibility, of obtaining certain colours, and notably the combination of several colours, such as red and black colours for example. More generally still, there are difficulties in obtaining the same uniform, predictable and reproducible colour.

### SUMMARY OF THE INVENTION

Thus, the general objective of the present invention is to propose a solution for manufacturing a ceramic component, in particular for a timepiece, which does not have the drawbacks of the prior art.

More specifically, a first object of the present invention is to propose a solution for manufacturing a ceramic component that makes it possible to obtain a ceramic whose colour is controlled, notably making it possible to obtain a multicoloured, notably two-tone, notably red and black result.

A second object of the present invention is to propose a solution for manufacturing a ceramic component, the colour of which is reliable and reproducible.

A third object of the present invention is to propose a solution for manufacturing a ceramic component which is as simple as possible and which makes it possible to obtain a ceramic having suitable technical properties, compatible with use as a timepiece component.

For this purpose, the invention is based on a process for manufacturing a ceramic timepiece component, characterized in that it comprises the following steps:
manufacturing an intermediate component in the form of green body based on ceria-zirconia,
totally or partially debinding the intermediate component to obtain a debound (sometimes designated as “debinded”) intermediate component;
locally impregnating the debound intermediate component with at least one solution comprising at least one metal salt, by or on one portion only of its surface, to obtain an impregnated debound intermediate component;
sintering and thermally treating the impregnated debound intermediate component by at least one step of heat treatment under a reducing atmosphere.

The invention also relates to a ceramic timepiece component, characterized in that it is based on ceria-zirconia, in that it is a monobloc one-piece part and two-tone, or even multicoloured, comprising at least a first portion in a first colour and a second portion in a second colour different from the first colour, notably comprising a red first colour and a black second colour.

The invention is more specifically defined by the claims.

### BRIEF DESCRIPTION OF THE DRAWINGS

These subjects, features and advantages of the present invention will be described in detail in the following non-limiting description of one particular embodiment given with reference to the appended figures, in which:

FIG. 1 represents a flow chart of the steps of the process for manufacturing a ceramic timepiece component according to one embodiment of the present invention.

FIGS. 2a to 2c represent the change in temperature as a function of time according to three examples of heat treatments according to three variants of the embodiment of the invention.

FIG. 3 depicts a bezel disc obtained after the step of sintering under an oxidizing atmosphere which corresponds to a first sub-step of heat treatment according to a first example of an embodiment of the invention.

FIG. 4 depicts the bezel disc from FIG. 3 obtained after a step of heat treatment under a reducing atmosphere which corresponds to a second sub-step of heat treatment according to the first example of an embodiment of the invention.

FIG. 5 comprises two tables detailing the properties of several ceramics obtained according to various exemplary embodiments of the invention.

FIG. 6 illustrates bezel discs obtained by an embodiment of the invention from raw materials comprising different proportions of cerium oxide and of alumina.

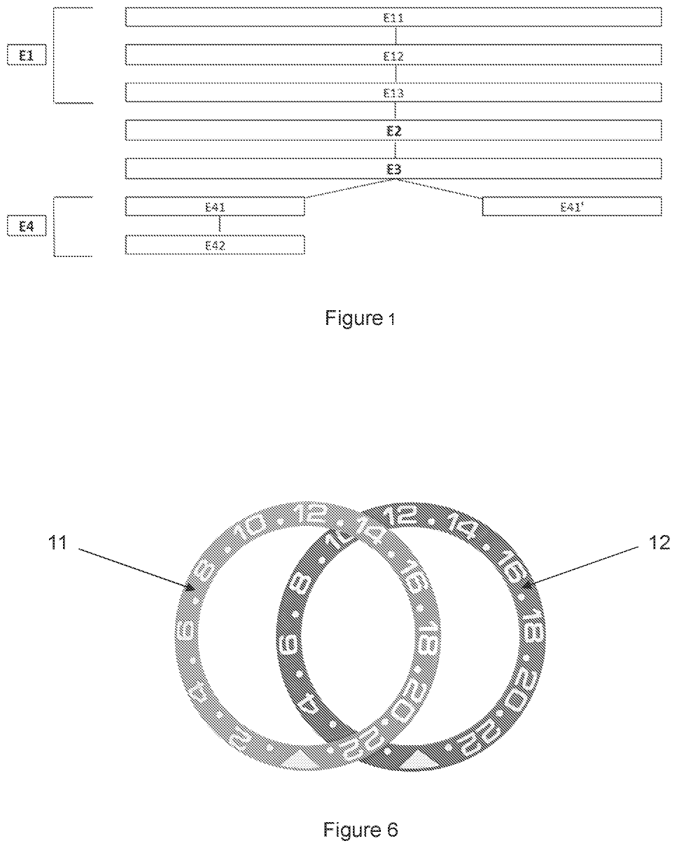

### DETAILED DESCRIPTION OF PARTICULAR EMBODIMENTS

Hereinafter, a ceramic component denote an element made of a material comprising mainly at least one dense ceramic. A “dense” ceramic is understood to mean a ceramic whose density is between 95% and 100% of the theoretical density of the material considered. In this document, the terms “ceramic” or “technical ceramic” denote dense materials based on stabilized zirconium oxide.

Furthermore, “based on zirconia” is understood to mean a material which comprises in all cases mostly a zirconia component, in a weight proportion of at least 50%, or even of at least 75%, or even of at least 90%. For example, the ceramic material according to the invention comprises at least 50% by weight of zirconia.

In all cases, the (i.e. dense) ceramic according to the invention contains no organic compound. Thus, the generic term “bound ceramic” (sometimes designated as “binded ceramic”) will denote a composite material consisting of ceramic and a binder, generally consisting of one or more organic compounds, in variable proportions. The term “green body” will denote a bound and shaped ceramic. At this stage, the ceramic is unfired.

The process of manufacturing a ceramic body according to an embodiment of the invention comprises the steps schematically detailed below.

A first step of the manufacturing process according to one embodiment consists in manufacturing an intermediate component E1 in the form of a green body based on ceria-zirconia. This intermediate component is in its finished or semi-finished form. At this stage, the component is unfired.

This first step may comprise the sub-steps explain below.

In a first sub-step, the process of manufacturing a ceramic component comprises the preparation of the raw material E11, i.e. a ceramic powder based on zirconia. According to one embodiment, this zirconia-based powder comprises cerium oxide CeO₂. For this reason, the term “ceria-zirconia” will be used to denote a ceramic powder or a ceramic, based on zirconia comprising by weight at least 50% of zirconia, and cerium oxide. According to one embodiment, the cerium oxide is present in a weight proportion of between 3% and 6%, or even between 3% and 5% of the total. Furthermore, the zirconia-based powder is stabilized with yttria (or yttrium oxide) (Y₂O₃), for example with a proportion of between 1.4 mol % and 4 mol % of yttrium oxide Y₂O₃, which proportion is calculated relative to the zirconia; the proportion of yttria is calculated according to: n(Y₂O₃)/[n(Y₂O₃)+n(ZrO₂)], with n being the amount of material. Lastly, advantageously, the powder comprises alumina. This alumina is advantageous for its effect on the final colour. It may be introduced at a later stage of the process, alternatively to or in addition to its introduction into the zirconium-based powder at this stage. The proportions of alumina may for example vary between 0.1% and 1% by weight. This proportion has an effect on the final colour obtained, notably the hue and the opacity.

A second sub-step of the manufacturing process consists in incorporating a binder E12 into the ceramic powder obtained by the first sub-step. Such a binder generally consists of one or more organic compounds. A bound ceramic powder is then obtained.

A third sub-step consists of a shaping E13 of the ceramic component, which makes it possible to obtain the intermediate component. To that end, a first approach comprises a step of pressing a cluster of bound particles obtained at the end of the second sub-step: in such a process, the second sub-step prepares a bound ceramic powder in the form of spray dried granules for pressing. A second approach consists of a shaping by injection into a mould. In such a case, the preparation resulting from the second sub-step is a bound ceramic powder referred to as “feedstock”. A third approach consists of a shaping by casting into a mould, commonly referred to as slip casting, followed by drying. In such a case, the preparation resulting from the second sub-step is a bound ceramic powder in suspension, referred to as slurry or slip. At the end of the third sub-step, a ceramic component is obtained, referred to as a green body as defined previously, which has a shape approaching its final shape and contains both the ceramic powder and the binder. Other shaping techniques could alternatively be used, such as gel casting, freeze casting or else coagulation casting techniques.

A second step of the embodiment consists in totally or partially debinding E2 the intermediate component to obtain a debound intermediate component. This debinding, applied to the intermediate component, can be carried out in several ways:
either by a heat treatment;
or by a treatment using a solution (solvent), which may for example be aqueous;
or in a mixed manner, using a solution (solvent) and a heat treatment combined.

This step gives rise to the extraction of at least one portion of the binders: it is therefore a total debinding or a partial debinding. Further simplification of the notations, this step is then referred to as “debinding”. The resulting component is at least partially debound. At this stage, it forms a single-material body, which is referred to as debound intermediate component. Besides this debinding, step E2 may optionally incorporate a “pre-sintering” heat treatment, which enables a start of densification (porosity reduction) of the component to make it less fragile during handling operations. During such a single heat treatment, the debinding may be considered to take place up to 450° C., and the pre-sintering to take place at higher temperatures. The term debinding will therefore be used in the broad sense, which can include an additional pre-sintering.

The third step consists in locally impregnating E3 the debound intermediate component with at least one solution comprising at least one metal salt, on one portion only of its surface, to obtain a (locally) impregnated debound intermediate component. The location of the impregnated zones on the surface of the component is a determining factor for the aesthetics of the final result. These impregnated zones may represent geometric portions of the surface. They may also completely cover one surface of the component, or even completely cover all the surfaces of the component.

This impregnation step is for example carried out according to the method described in document CH707424. It may comprise the use of an aqueous solution in which the additional element is present in the form of a metal salt. It may be applied in various ways, for example manually or by inkjet printing. Various aqueous solutions of salts (nitrates, chlorides, etc.) and of metals (nickel, iron, cobalt, aluminium, etc.) may be used, in order to obtain different colours. For example, the metal salt may be chosen from the elements Co, Fe, Mn, Ni, and Al. Specifically, this impregnation introduces salts into the ceramic, which will form pigments able to then be reduced: these pigments, depending on their nature, take on different colours once reduced, as will be illustrated hereinafter on the basis of particular exemplary embodiments. In particular, they could turn orange, brown grey and advantageously black. As an observation, the elements Co, Fe, Mn, Ni make it possible to obtain a black colour. As an observation, alumina, which was envisaged in the composition of the initial ceramic powder for its effect on the colour, could as an alternative or in addition be introduced into the debound intermediate component via this impregnation step, for example by means of aluminium salts. As an observation, during this impregnation step, one or more different metal salts can be used for the impregnation. As a further observation, the impregnation step may be carried out on the intermediate component which is not totally debound, the final stages of the debinding being carried out subsequently.

The fourth step of the process consists in thermally treating E4 the (locally) impregnated debound intermediate component to obtain the finished or nearly finished component, which consists in sintering it and in reducing it.

As is known, sintering makes it possible to densify the component by eliminating the pores originating from the debinding (or by continuing the elimination of the pores, if step E2 incorporated a pre-sintering). The sintering consists of a heat treatment, more particularly of a high-temperature firing.

The final mechanical properties and also the final colours of the component appear only at the end of this fourth step E4 and are from the result of the reactions between the various constituents of the component and also with the gases present in the furnace, which come into play during the heat treatment. These reactions are complex.

According to a first embodiment, the fourth step of heat treatment advantageously comprises at least two sub-steps carried out under different conditions.

Notably, the first sub-step consists of an oxidizing sintering E41, preferentially in air. For this, a heat treatment at a temperature between 1400° C. and 1650° C., or even between 1450° C. and 1550° C., for a thermal hold of at least 30 minutes, is advantageously carried out. As a variant, a heat treatment in any other oxidizing atmosphere could be carried out. At the end of this first sub-step, it is noted that the impregnated and non-impregnated zones of the debound intermediate component have colours that are different from one another. Furthermore, these colours are intermediate colours.

The process then comprises at least a second sub-step of heat treatment of the component under a reducing atmosphere E42. This second sub-step makes it possible to modify the colour of at least one of the zones of the component. Particularly, the total or partial reduction of the cerium oxide (from Ce+IV to Ce+III) makes it possible to form on at least one non-impregnated zone of the component a colour ranging from bright red to orange. Moreover, it is also observed that it is possible to obtain a very dark colour of the impregnated zones, notably a black colour (notably after impregnation with cobalt salts). Alternatively, it is also observed that it is possible to obtain a lighter colour of the impregnated zones, notably an orange colour (notably after impregnation with aluminium salts). Thus, the process according to the invention is particularly suitable for obtaining a two-tone, notably red and black or red and orange, ceramic having a very attractive appearance. For the second sub-step of heat treatment of the component under a reducing atmosphere E42, a heat treatment at a temperature between 1200° C. and 1550° C., or even between 1350° C. and 1500° C., for a thermal hold of at least 30 minutes, is advantageously carried out. For E42, the atmosphere advantageously contains hydrogen, notably that is pure, or as a mixture for example with nitrogen, or with an inert gas such as argon. At the end of this second sub-step of reductive heat treatment, the final colours are obtained, which differ from the intermediate colours.

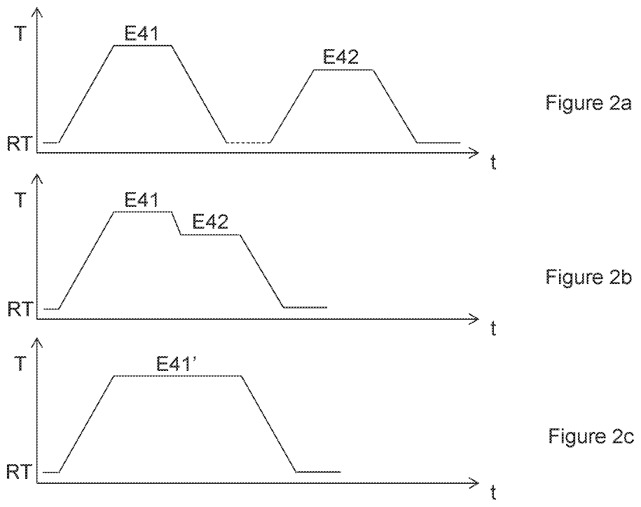

FIG. 2a illustrates the change in temperature as a function of time for the two sub-steps E41 and E42, according to the first embodiment described above. At the end of the first sub-step E41, the component is cooled to room temperature RT before starting the second sub-step E42.

As an observation, alternatively, the two sub-steps E41 (oxidizing sintering) and E42 (reductive heat treatment) may follow one another without requiring the component to be cooled to room temperature. Thus, the entire step E4 can be carried out in the same furnace, in which the gas could be changed (to go from an oxidizing atmosphere to a reducing atmosphere). This embodiment variant is depicted by FIG. 2b.

As an observation, according to another variant, the two sub-steps E41 (having a sintering objective) and E42 (having a reductive heat treatment objective) can be combined in a single step E41′ of reductive sintering. This variant is depicted by FIG. 2c. For this reductive sintering step E41′, a heat treatment at a temperature between 1400° C. and 1650° C., or even between 1450° C. and 1550° C., for a thermal hold of at least one hour, is advantageously carried out. Furthermore, the atmosphere advantageously contains hydrogen, notably that is pure, or as a mixture for example with nitrogen, or with an inert gas such as argon.

In the three variants of the embodiment, it is possible to obtain a component or a portion of component made of two-tone ceramic.

Optionally, the process of manufacturing the component may comprise an additional step consisting in making recesses in the surface of the timepiece component (resulting from step E2, E3 or E4), for example using a laser or a conventional tool. Optionally, the process may comprise an additional step consisting in coating all or part of the surface of the timepiece component resulting from the sintering step in order to deposit a coating on all or part of its surface, for example in recesses. Such a coating step may be carried out by the physical vapour deposition (PVD) technique. It makes it possible for example to deposit a metal, such as platinum, advantageously with a adhesion layer. Lastly, the process may comprise another, optional, finishing step, for example a grinding and/or polishing and/or sandblasting and/or satin-finishing step.

Finally, the process of manufacturing a timepiece component according to the invention has the following advantages:
The impregnation carried out makes it possible to attain a coloration over a significant depth of the component, and not only superficially. Thus, in the case of surface wear, there is no impact on the colour of the component;
The at least two portions of different colours of the component are in monobloc form, made of a one-piece part. In other words, there is no fragile interface or border between these two portions, as would be the case if the two colours were obtained by elements manufactured at least in part separately and assembled subsequently;
The component made of zirconia-based sintered technical ceramic has high mechanical properties, compatible with watchmaking applications. Specifically, it notably has a high fracture toughness and a high failure stress;
Moreover, the various colours of the ceramic component are obtained in a simple and easily reproducible manner;
The impregnation by the salts forms pigments during the sintering, and not a solid solution, which makes it possible to obtain an opacity of the colours. The process is thus suitable for obtaining a dark zone, more particularly for obtaining a black zone;
In addition, the process operates with several ceria-zirconia compositions, which make it possible to obtain red zones, the precise colour of which is controllable, notably as a function of the proportions of cerium oxide and alumina used;
The result of this is that the process is particularly suitable for the manufacture of a zirconia-based ceramic comprising at least one portion of black colour and one portion of red colour;
In addition, the process makes it possible to obtain a sharp border between the zones of different colours.

The invention also relates to the material itself obtained by the manufacturing process according to the invention and to a timepiece component made of ceramic, based on ceria-zirconia, i.e. a sintered technical ceramic based on ceria-zirconia. This material and the timepiece component comprising this material advantageously comprise at least a first portion in a first colour and a second portion in a second colour different from the first colour, notably a red first portion and a black second portion.

As an observation, the colour of the technical ceramic is measured by spectrophotometry. The measurements are carried out in reflection with an aperture of 7 mm for a measurement diameter of 4 mm; the geometry of the measurement device corresponds to a diffuse illumination and a measurement of the spectra at 8°. If the component does not have a sufficient flat surface area, a control pellet is used to carry out the measurement. The reflectance measurements are carried out between 360 nm and 740 nm, and the colour is evaluated with the hypothesis of an observer at 10° and the illuminant D65. The luminosity L* and the chromaticity values a* and b*, the chroma C* and the hue angle h*, are evaluated in the space defined by the International Commission on Illumination, CIE L*a*b*, as indicated in the “Technical Report of Colorimetry” CIE 15: 2004. The measurements are carried out in SCI (Specular Component Included) mode and SCE (Specular Component Excluded) mode. Furthermore, spectrophotometry measurement is carried out on a component with a polished surface finish, preferably having a roughness defined by a normalized roughness parameter Ra equal to 2 nm±0.2 nm. As an observation, the parameter Ra is measured according to the (ISO 4287) standard.

Thus, more specifically, according to the standardised approach explained above, the invention makes it possible to form a multicoloured ceramic timepiece component that may comprise at least one portion of red colour, defined by the following colorimetric parameters in SCI mode: L* between 47.5 and 54.1, or even L* between 47.8 and 49.5, or even L* between 48.0 and 49.2, a* between 11.7 and 25.1, or even a* between 14.4 and 17.7, or even a* between 13.4 and 16.4, and b* between 5.2 and 15.5, or even b* between 5.8 and 8.8, or even b* between 5.9 and 8.0. Furthermore, the component may comprise at least one portion of dark colour, notably black colour, defined by the following colorimetric parameters in SCI mode: L* less than 47.0, or even L* less than 45.6, or even L* less than 45.4, or L* between 43.0 and 47.0, or even L* between 44.3 and 45.6, or even L* between 45.0 and 45.4, a* between −0.5 and 1, or even a* between −0.1 and 1.0, or even a* between and 0.9, b* between −1 and 1.6, or even b* between −0.8 and 1.4, or even b* between 0.3 and 1.1.

Furthermore, the timepiece component comprising this material based on technical ceramic is in a monobloc form and/or that forms a single piece. It is a one-piece part. Specifically, there is no mechanical physical discontinuity between two parts of different colours which might introduce a weakness, as it would be the case with two separate parts that are assembled, for example by an overmoulding or bi-injection moulding or co-pressing process, following which there is still a risk of accidental separation of the two separate parts assembled, which is not the case with the component of the invention. The timepiece component notably has a continuity of concentration or of chemical composition of cerium, in addition to the continuity of the zirconia. The component comprises at least a continuity of concentration in its core for these two elements (Zr and Ce), but not for the additional elements, this core being identical and continuous, made of a one-piece part, for the portions of different colours of the timepiece component. This core may be considered to be the zones of sufficient depth in the material, which are not impacted by the colorations of the process, described previously; alternatively, it is possible to implement impregnation parameters which colour the entire depth of thin parts. In addition, the timepiece component is shaped by a single manufacturing phase, which makes it possible to achieve the final shape from the same raw material, for example from a same ceramic powder, and simultaneously, during a same sintering operation, for at least two portions of different colours.

The material based on ceria-zirconia of the invention advantageously comprises a weight proportion of cerium oxide of between 3% and 5% (noted wt %).

The invention also relates naturally to a timepiece component comprising such a technical ceramic, based on ceria-zirconia and sintered. Such a timepiece component may be a watch bezel, a dial, an index, a winding crown, a push-piece or any other watch exterior component or any supply of a timepiece movement. This timepiece component may be fully made of the ceramic material based on ceria-zirconia, or alternatively partially. For example, this timepiece component may comprise a body completely made of ceramic based on ceria-zirconia according to the invention, onto which other separate elements are fastened.

The invention also relates to a timepiece, notably a wristwatch, comprising such a sintered technical ceramic according to the invention or at least one timepiece component as described above.

Some examples of implementation of the invention will be described below.

According to a first example, the timepiece component manufactured is a bezel disc.

The first step of the process comprises the sub-steps detailed below, which correspond to the more general process described previously.

The first sub-step consists in selecting the raw material: according to this example, the choice is oriented toward a ceramic powder based on zirconia, stabilized with yttria (3 mol %), containing cerium oxide (3 wt %) and alumina (0.1 wt %).

The second sub-step of the process consists in incorporating the binder into the ceramic powder obtained by the first sub-step in order to obtain a feedstock.

The third sub-step consists of the shaping of the ceramic component by injection into a mould. A bezel disc made of bound, unfired ceria-zirconia, constituting a green body, which corresponds to the intermediate component according to name chosen previously, is then obtained.

The second step consists in debinding the green body by a heat treatment, and incorporates in this case a pre-sintering. The debinding and the pre-sintering are carried out by a single heat treatment. The intermediate components are heated to at least 750° C. for one hour, in an ambient air furnace.

The third step of the process is the impregnation step. For this, use is made of an aqueous solution in which the additional element is present in the form of a metal salt. The impregnation is carried out here manually (it could alternatively be carried out by inkjet), by using an aqueous solution of aluminium and cobalt salts, produced for example by dissolving the following solids: Al(NO₃)₃·9H₂O, Co(NO₃)₂·6H₂O to obtain a solution of the following composition: 1 M Al(NO₃)₃ and 0.5 M Co(NO₃)₂. The impregnation is carried out on one half of the ring forming the future bezel disc.

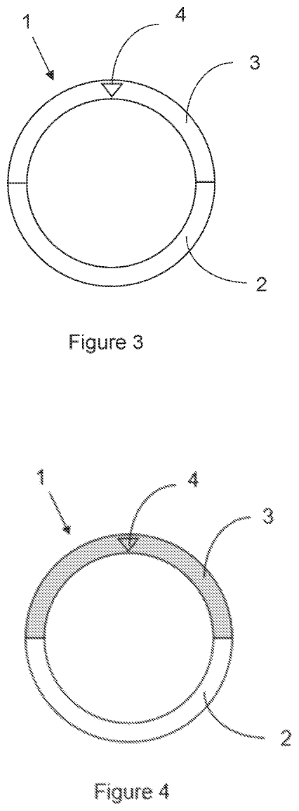

Lastly, the fourth heat treatment step comprises firstly a sintering with a thermal hold of 2 hours at 1480° C., in ambient air. At the end of this first heat treatment (which forms a first sub-step of oxidizing sintering), the bezel disc 1, represented schematically by FIG. 3, is yellow at the non-impregnated location 2 and blue at the impregnated location 3 (this blue being due to the formation of CoAl₂O₄ compounds formed from cobalt salts introduced by impregnation). In this example, the bezel disc is then ground. The fourth heat treatment step then comprises a second sub-step comprising a heat treatment under a reducing atmosphere. The bezel disc is subjected to a heat treatment with a thermal hold of one hour at 1400° C. in a reducing atmosphere composed of hydrogen H₂ and argon Ar. The ceria-zirconia turns red at the end of this reducing heat treatment, in the non-impregnated zones 2. The impregnated zones 3, which were blue at the end of the sintering in air, turn black, as represented in FIG. 4.

Thus, the end of the process according to the invention, the bezel disc made of ceria-zirconia is two-tone: it is red at the non-impregnated location and black at the impregnated location.

In this example, the bezel discs, which comprise recesses 4 (see FIGS. 3, 4) (notably formed during the injection), are then sandblasted, coated with a deposit of platinum by PVD, and then polished. Thus, the recesses have the colour of the platinum, and the bezel disc is two-tone, black and red.

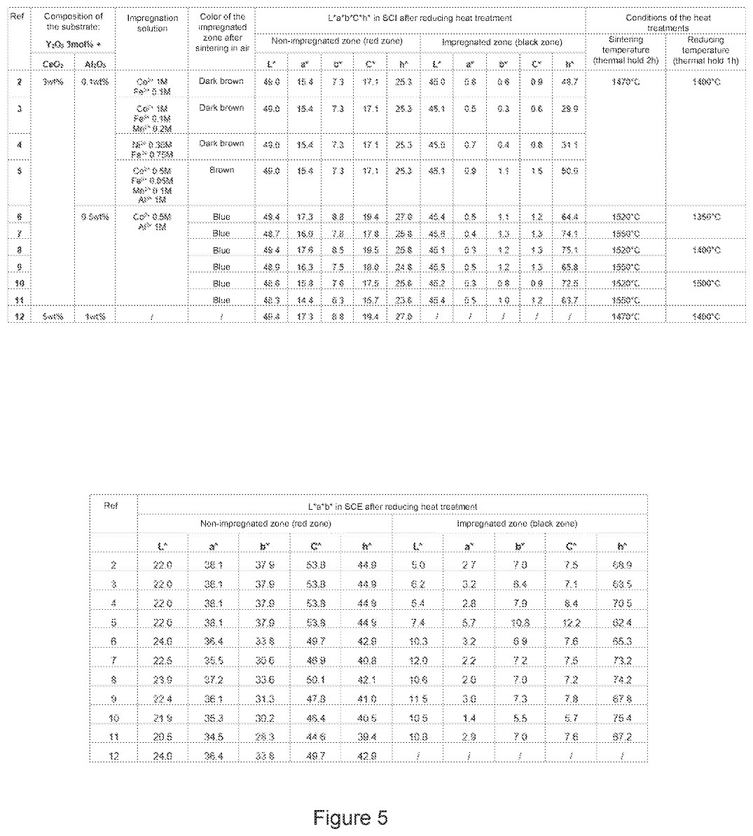

Of course, the invention is not limited to the preceding example. For this purpose, the table presented in FIG. 5 illustrates additional examples (numbered from 2 to 12), corresponding to various embodiments of the invention. The difference between these examples is that various parameters are modified, including the composition of the ceramic powder, that of the impregnation solution (nature of the metal salts, concentration, etc.), the temperature of debinding, the temperature of the sintering in air, the temperature of the reduction (which is carried out under forming gas (reducing mixture of hydrogen H₂ and nitrogen N2) for samples 2 to 5 and 12; and in a mixture of 20% hydrogen and 80% argon for samples 6 to 11). The resulting colours are measured by spectrophotometry, as specified previously. The results illustrate that it is possible to obtain components made of ceria-zirconia, in two colours: here, one is red (and may have several hues, as far as orange) and the other is black (with several values of L*a*b*C*h*). As an observation, the surface of the components is polished. To this end, the roughness of this polish surface is defined by the normalised roughness parameter Ra, equal to 2 nm±0.2 nm. This parameter Ra is measured according to the standard ISO 4287; it represents the (arithmetic) mean height of the roughness. The reference sample 12 is monochrome since it has not been impregnated. By this process, examples of two-tone components are obtained, the red portion of which may be described by L* between 48.3 and 49.4, a* between 14.4 and 17.6, b* between 6.3 and 8.8, in SCI mode and L* between 20.5 and 24.0, a* between 34.5 and 38.1, b* between 28.3 and 37.9, in SCE mode; the black portion may be described by L* between 45 and 45.6, a* between 0.3 and 0.9, b* between 0.3 and 1.3, in SCI mode and L* between 5.0 and 12.0, a* between 1.4 and 5.7, b* between 5.5 and 10.8, in SCE mode.

In all the examples, the zirconia used is stabilized with yttrium oxide, in a proportion of 3 mol % of yttrium oxide. This proportion could vary without departing from the invention, for example in the range between 1.4 mol % and 4 mol %. Furthermore, the proportions of cerium oxide in the yttria-stabilized zirconia can vary; a proportion of 3 wt % is chosen in these examples. The proportions of alumina in the substrate may also vary: proportions of 0.1 wt % and 0.5 wt % are chosen according to these examples.

FIG. 6 illustrates an example of impact of the variation of proportion of cerium oxide and alumina in the chosen raw material chosen, on the resulting red colour, after a sintering in air with a thermal hold of two hours at 1470° C. and a reduction with a thermal hold of one hour at 1400° C. under a reducing atmosphere composed of forming gas. The component located on the left in FIG. 6 is a bezel disc 11 of orangey colour, made of yttria-stabilized zirconia containing 5 wt % of cerium oxide CeO₂ and 1 wt % of alumina Al₂O₃, corresponding to Example 12 in the tables from FIG. 5. The component located on the right in FIG. 6 is a bezel disc 12 made of yttria-stabilized zirconia, of red colour, containing 3 wt % of cerium oxide CeO₂ and 0.1 wt % of alumina Al₂O₃ (in terms of composition and heat treatments, the latter corresponds to the red zones of the components constituting Examples 2 to 5 in the table from FIG. 5). As an observation, neither of these two components was impregnated.

In addition to the preceding elements, several other manufacturing parameters have an impact, notably on the colours. A person skilled in the art will be able to define these parameters according to the targeted result. The main ones are:
The gaseous atmosphere used for the reducing treatment. It may for example contain hydrogen in various proportions (from 5% to 100%) and have various additional gases, notably argon Ar and/or nitrogen N₂. The flow of gas in the chamber is itself also variable;
The temperatures of the sintering and air, or more generally in an oxidizing atmosphere, or alternatively in a reducing atmosphere (step E41′), advantageously between 1400° C. and 1650° C., and more particularly between 1450° C. and 1550° C. and/or for a thermal hold of at least 30 minutes for E41 or at least one hour for E41′;
The durations of the sintering thermal hold, which may vary from 30 minutes to several hours;
The temperatures of the reduction in the second heat treatment sub-step in a reducing atmosphere E42, advantageously between 1200° C. and 1550° C., and more particularly between 1350° C. and 1500° C.;
The duration of the thermal hold for the reduction, advantageously between 30 minutes and several hours for E42.
The shaping method (injection, pressing, etc.).

1. A process for manufacturing a ceramic timepiece component, comprising:
manufacturing an intermediate component having a form of a green body based on ceria-zirconia,
totally or partially debinding the intermediate component to obtain a debound intermediate component;
locally impregnating the debound intermediate component with at least one solution comprising at least one metal salt, on one portion only of a surface of the debound intermediate component, to obtain an impregnated debound intermediate component;
sintering and thermally treating the impregnated debound intermediate component by performing at least one heat treatment under a reducing atmosphere.

2. The process according to claim 1, wherein the sintering and thermally treating the impregnated debound intermediate component comprises:
sintering the impregnated debound intermediate component under an oxidizing atmosphere, then
performing the heat treatment under a reducing atmosphere.

3. The process according to claim 1, wherein the manufacturing the intermediate component having the form of the green body made of ceria-zirconia uses a ceramic powder based on yttria-stabilized zirconia.

4. The process according to claim 3, wherein the ceramic powder based on zirconia comprises alumina in a weight proportion in a range of from 0.1% to 1%.

5. The process according to claim 1, wherein the sintering and thermally treating the impregnated debound intermediate component comprises:
sintering the impregnated debound intermediate component under an oxidizing atmosphere, then
performing the heat treatment under a reducing atmosphere),
wherein the sintering the impregnated debound intermediate component under an oxidizing atmosphere subjects the impregnated debound intermediate component to a temperature in a range of from 1400° C. to 1650° C., for a thermal hold of at least thirty minutes, and/or the heat treatment under a reducing atmosphere subjects the impregnated debound intermediate component to a temperature in a range of from 1200° C. to 1550° C., in a reducing atmosphere, with a thermal hold of at least thirty minutes.

6. The process according to claim 1, wherein the sintering and thermally treating the impregnated debound intermediate component comprises a single operation of reductive sintering subjecting the impregnated debound intermediate component to a temperature in a range of from 1400° C. to 1650° C., in a reducing atmosphere, for a thermal hold of at least one hour.

7. The process according to claim 1, wherein the partially impregnating the debound intermediate component uses a solution comprising at least one metal salt selected from the group consisting of Co, Fe, Mn, Ni, and Al.

8. The process according to claim 7, wherein the sintering and thermally treating the impregnated debound intermediate component makes it possible to form a multicoloured ceramic timepiece component, comprising:
at least one first non-impregnated surface portion having a red color, defined by first colorimetric parameters in SCI mode:
L* in a range of from 47.5 to 54.1,
a* in a range of from 11.7 to 25.1,
b* in a range of from 5.2 to 15.5, and/or
at least one second portion of dark color in an impregnated surface area, defined by second colorimetric parameters in SCI mode:
L* less than 47.0,
a* in a range of from −0.5 to 1,
b* in a range of from −1 to 1.6,
wherein spectrophotometry values are based on measurement carried out on a component with a polished surface finish.

9. The process according to claim 1, further comprising:
coating at least a portion of a surface of the timepiece component resulting from the sintering, and/or
grinding and/or polishing, and/or
sandblasting, and/or
satin-finishing.

10. A ceramic timepiece component, based on ceria-zirconia, which is a monobloc one-piece part and two-tone or multicolored, comprising:
at least a first portion in a first color, and
at least a second portion in a second color different from the first color,
wherein the first color is a red color and the second color is a black color.

11. The ceramic timepiece component according to claim 10, comprising at least one core that is continuous, at least mechanically and/or in terms of concentration, the core extending from the at least one first portion to the at least one second portion.

12. The ceramic timepiece component according to claim 10, wherein the first portion and the second portion are obtained from a same powder formed in a same operation, and thermally treated in a same operation.

13. The ceramic timepiece component according to claim 10, comprising a weight proportion of cerium oxide in a range of from 3% to 5%.

14. The ceramic timepiece component according to claim 10, wherein
the first portion is a portion of red color defined by first colorimetric parameters in SCI mode:
L* in a range of from 47.5 to 54.1,
a* in a range of from 11.7 to 25.1,
b* in a range of from 5.2 to 15.5, and/or
the second portion is a portion of black color defined by second colorimetric parameters in SCI mode:
L* less than 47.0,
a* in a range of from −0.5 to 1,
b* in a range of from −1 to 1.6,
wherein spectrophotometry values are based on measurement carried out on a component with a polished surface finish.

15. The ceramic timepiece component according to claim 10, which is a watch bezel, a dial, an index, a winding crown, a push-piece, another watch exterior component, or another portion of a timepiece movement.

16. A timepiece or jewellery part, which comprises a ceramic timepiece component as claimed in claim 10.

17. The process according to claim 1, wherein the sintering and thermally treating of the impregnated debound intermediate component comprises a single operation of reductive sintering.

18. The process according to claim 3, wherein the ceramic powder based on yttria-stabilized zirconia comprises a proportion in a range of from 1.4 mol % to 4 mol % of yttrium oxide Y₂O₃ calculated relative to the zirconia, and comprises cerium oxide in a weight proportion in a range of from 3% to 6%.

19. The process according to claim 5, wherein the sintering of the impregnated debound intermediate component under an oxidizing atmosphere subjects the impregnated debound intermediate component to a temperature in a range of from 1450° C. to 1550° C., for a thermal hold of at least thirty minutes.

20. The process according to claim 5, wherein the heat treatment under a reducing atmosphere subjects the impregnated debound intermediate component to a temperature in a range of from 1350° C. to 1500° C., in a reducing atmosphere comprising H₂, with a thermal hold of at least thirty minutes.
